(19) United States
(12) Patent Application Publication
(10) Pub. No.: US 2013/0191240 A1
(43) Pub. Date: Jul. 25, 2013

(54) METHOD AND SYSTEM FOR PROVIDING AT LEAST ONE CUSTOMIZED SHOE TO A USER

(71) Applicant: Nathaniel Lasry, Hampstead (CA)

(72) Inventor: Nathaniel Lasry, Hampstead (CA)

(21) Appl. No.: 13/824,501

(22) PCT Filed: Sep. 22, 2011
(86) PCT No.: PCT/CA11/01063

§ 371 Date: Mar. 18, 2013

Related U.S. Application Data
(60) Provisional application No. 61/385,303, filed on Sep. 22, 2010.

(51) Int. Cl. G06Q 30/06

(52) U.S. Cl. CPC G06Q 30/0621
USPC 705/26.5

(57) ABSTRACT

There is disclosed a method for providing at least one customized shoe to a user, the method comprising receiving biometric foot data corresponding to the user; receiving an order of a selected shoe model placed by the user; forwarding the biometric foot data and the order to a manufacturer of the selected shoe model for enabling the manufacturer to manufacture at least one customized shoe based on the biometric foot data and on the order and to further deliver the at least one customized shoe to the user. There is also provided a system for providing at least one customized shoe to a user.

### CROSS REFERENCE TO RELATED APPLICATION

This application claims priority of U.S. Provisional Patent Application having Ser. No. 61/385,303, which was filed on Sep. 22, 2010 and is entitled “METHOD FOR PROVIDING CUSTOMIZED SHOES”, the specification of which is hereby incorporated by reference.

### TECHNICAL FIELD

This invention pertains to a general method of using biometric data collected from a user to enable the customization of a product. Biometric data are collected from a user and used to customize any kind of brand of shoe for the said user. This also relates to a system for providing at least one customized shoe to the user.

### BACKGROUND

In a study published in “Medicine and Science in Sports and Exercise” in 2004, pedometer researcher Dr. Catrine Tudor-Locke showed that women take on average 5210 steps a day while men take on average 7192 steps a day. At such average rates of steps per day, feet need proper protection. Shoes are important clothing apparels because they constitute the main interface between the ground and the foot. Shoes must properly protect and comfort the human foot.

For most people, the size of the right foot differs slightly from the size of the left foot. Usually neglected, this albeit small difference is often not negligible and can have an impact on the foot and back over thousands of steps (i.e. a day). Currently, users with noticeable differences in right and left foot-size are recommended to purchase a ready-to-wear pair of shoes that fits the larger foot. This is a drawback because users are asked to neglect the comfort, support and protection of the smaller foot.

Besides forcing the fit to the larger foot, predetermined sizes may sometimes neglect the proper fit for both feet. For instance, users are sometimes faced with situations where their feet ‘fall between sizes’, that is, the shoe size does not properly match either foot size.

In addition, other variables besides foot-length and width may be pertinent when considering shoes such as the dimensions of the foot's arch. Although arch support is a critical part of foot function and comfort, little to no choice in the kind and extent of arch support is given to purchasers of ready-to-wear shoes.

Another drawback is apparent when a user tries to purchase a pair of shoes in a physical location but finds no available size or model. This can create frustration and shoppers may choose to cancel their order and stop shopping altogether.

Users may choose to purchase shoes from online vendors such as Zappos.com or Shoes.com. An important drawback with current online vendors is that users are reticent to purchase a shoe they have not tried on. How can one be sure it will fit? Some estimate returns from online shoe purchases at 30% of all orders of shoes. This severely limits the potential market for online shoe vendors.

Nike™ has recently launched a line of ‘customized’ shoes with their NikeiD line (http://nikeid.nike.com/nikeid/index.jsp). However, this ‘customization’ more accurately refers to a cosmetic personalization. That is, users can choose materials and different unique combinations of colors for the laces, body and base of the shoe. Users cannot systematically customize different shoe lengths for right and left shoes or customize the arch-support for the personalized shoe.

To provide better customization, Aetrex™ has developed the iStep SP5000 which quickly collects foot length, width and arch biometric data. Aetrex™ uses this data to sell customized insoles or Aetrex™ brand shoes. The skilled addressee will appreciate that a shoe manufacturer trademark is usually a determining factor when considering shoes for purchase. Providing customization for only certain models of a restrained number of shoe manufacturers is unacceptable from that perspective.

There is a need for a method that will overcome at least one of the above-identified drawbacks.

Features of the invention will be apparent from review of the disclosure, drawings and description of the invention below.

### BRIEF SUMMARY

According to one aspect, there is provided a method for providing at least one customized shoe to a user, the method comprising: receiving biometric foot data corresponding to the user; receiving an order of a selected shoe model placed by the user; forwarding the biometric foot data and the order to a manufacturer of the selected shoe model for enabling the manufacturer to manufacture at least one customized shoe based on the biometric foot data and on the order and to further deliver the at least one customized shoe to the user.

In one embodiment, the biometric foot data comprises at least one of length, width, arch type and pressure distribution along a foot's plantar surface.

In one embodiment, the order is placed at a shoe vending venue.

In one embodiment, the shoe vending venue comprises a virtual shoe vending venue.

In one embodiment, the shoe vending venue comprises an existing shoe vending venue located at a given location.

In one embodiment, the acquisition of the biometric foot data is also performed at the shoe vending venue.

In one embodiment, the acquisition of the biometric foot data is performed for a fee.

In one embodiment, the forwarding of the biometric foot data and of the order is performed for a fee.

In one embodiment, the method further comprises, after receiving the biometric foot data: storing the biometric foot data in a database; before forwarding the biometric foot data and the order to a manufacturer, retrieving the biometric foot data from the database.

In one embodiment, the storage of the biometric foot data in the database is performed for a fee.

In one embodiment, the retrieval of the biometric foot data from the database is performed for a fee.

In one embodiment, the method further comprises, before forwarding the biometric foot data and the order to the manufacturer: acquiring an indication of the identity of the user; associating the indication of the identity of the user with the biometric foot data of the user.

In one embodiment, the retrieval of the biometric foot data from the database comprises: providing identification associated with the indication of the identity of the user in order to be able to access and retrieve the biometric foot data of the user.

In one embodiment, the database comprises an online database operatively connected to the Internet.

In one embodiment, the retrieval of the biometric foot data from the database comprises: using the indication of the identity of the user on a website to retrieve the biometric foot data from the database.

In one embodiment, the biometric foot data is provided directly by the user on the website.

In one embodiment, the database is operated by a third party.

In one embodiment, the biometric foot data is provided by the third party.

In one embodiment, the reception of the order of the selected shoe model comprises: providing, on the website, a list of available shoe models accessible by the user to enable the user to select a desired shoe model; receiving an indication of a desire to complete the order for the selected shoe model.

In one embodiment, the method further comprises: receiving an upfront payment associated with the order from the user.

In one embodiment, the payment is performed using a mode of payment selected from a group consisting of PayPal™, debit card, credit card, check and cash.

In one embodiment, the forwarding of the biometric foot data and of the order is performed via a data network.

In one embodiment, the data network comprises at least one of a local area network (LAN), a metropolitan area network (MAN) and a wide area network (WAN).

In one embodiment, the data network comprises the Internet.

In one embodiment, the method further comprises, before receiving the biometric foot data: acquiring the biometric foot data from the user.

In one embodiment, the acquisition of the biometric foot data is performed using an Aetrex™ iStep SP5000 foot analysis device.

In one embodiment, the method further comprises, after forwarding the biometric foot data and the order: manufacturing the at least one customized shoe.

In one embodiment, the manufacturing of the at least one customized shoe comprises: providing an existing shoe selected according to the order; inserting an appropriate insole in the existing shoe.

In one embodiment, the method further comprises, before inserting the appropriate insole in the existing shoe: selecting the appropriate insole from a plurality of existing insoles according to the biometric foot data.

In one embodiment, the method further comprises, before inserting the appropriate insole in the existing shoe: manufacturing the appropriate insole according to the biometric foot data.

In one embodiment, the at least one customized shoe is delivered to the user using one of postal service and a messenger service.

According to another aspect, there is also provided a system for providing at least one customized shoe to a user, the system comprising: a data network; a foot data acquisition unit operatively connected to the data network for acquiring biometric foot data of the user; a shoe vending venue operatively connected to the data network for enabling the user to select a given shoe model and to place an order of the selected shoe model; a shoe manufacturer operatively connected to the data network for receiving the biometric foot data and the order, and further for manufacturing customized shoes according to the biometric foot data and to the order, and further for delivering the at least one customized shoe to the user.

In one embodiment, the system further comprises a third party handling foot data operatively connected to the data network for receiving the biometric foot data and for forwarding the biometric foot data to the shoe manufacturer.

In one embodiment, the third party handling foot data further comprises a database for storing the biometric foot data.

In one embodiment, the foot data acquisition unit is further adapted to provide an indication of the identity of the user to the third party handling foot data.

In one embodiment, the third party handling foot data is further adapted for associating the biometric foot data of the user to the indication of the identity of the user.

An advantage of the method and system disclosed is that they enable a user to have access to customized shoes from a wide range of manufacturers. The user is not limited to a single shoe manufacturer which is of great advantage over the prior art.

Another advantage of the method and system disclosed is that using the embodiment disclosed herein, foot data may be collected using a given unique third party which will then provide the pertinent foot data to shoe manufacturers when required. The foot data of the user may therefore not be collected by many entities or widely disseminated which is greatly advantageous with respect to user privacy.

Another advantage of the method and system disclosed from the user's perspective is that given the stability of foot size, users can use previous biometric foot data to continue purchasing customized shoes. Repeat measurements of the feet are not required. Without having to move to a physical location, a user can still purchase a pair of customized shoes months to years after the biometric data was first collected.

Another advantage of the method and system from the manufacturers' perspective, provided the user agrees, is that manufacturers can use the user's biometric foot data to continue selling shoes, long after the initial biometric measurement. This eliminates the need for retail outlets and allows manufacturers to increase their margins by selling directly to customers. With biometric shoe data, manufacturers could even adopt a Dell™ business model and sell directly and exclusively to individuals.

### BRIEF DESCRIPTION OF THE DRAWINGS

For the invention to be readily understood, embodiments of the invention are illustrated by way of example in the accompanying drawings.

FIG. 1 is a flowchart showing an embodiment of a method for acquiring customized shoes.

FIG. 2 is a diagram which shows interactions between a user, a shoe vending venue, a foot data acquisition unit, a third party handling foot data and a shoe manufacturer according to one embodiment of the invention.

Further details of the invention and its advantages will be apparent from the detailed description included below.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

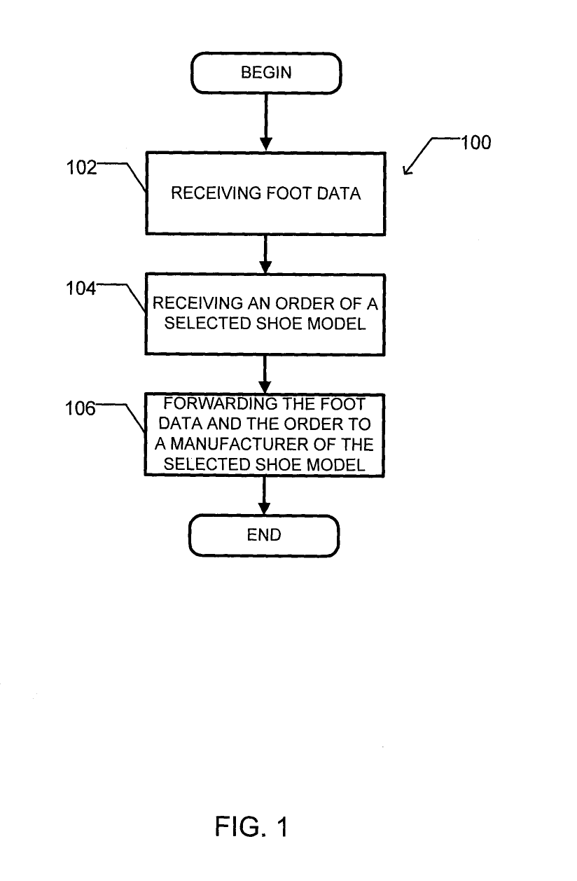

Referring to FIG. 1, an embodiment of a method for providing at least one customized shoe is shown.

According to processing step 102 biometric foot data are acquired and received. It will be appreciated that the foot data may be acquired according to various embodiments.

In one embodiment, the foot data comprises length, width, arch type and pressure distribution along the foot's plantar surface. Still in this embodiment, the foot data are acquired using Aetrex™ iStep SP5000 foot analysis device.

It will be appreciated that the foot data may be acquired according to various other devices and embodiments.

It will be appreciated that the foot data may be acquired at various locations. For instance the foot data may be acquired at shoe vending venues. Alternatively, the foot data may be acquired at other participating venues. Such participating venues may receive a fee for performing acquisitions of biometric foot data as further explained below.

Biometric foot data collection devices such as the Aetrex™ iStep SP5000 are portable. The physical location of the foot data acquisition can thus be anywhere from a physical store to an independent booth or even in the users' home or place of work.

According to processing step 104, a shoe model is ordered at a shoe-vending venue. Specifically, the user selects a given shoe model, places an order of the selected shoe model and the order is received.

It will be appreciated that the ordering of a shoe model may de done according to various embodiments.

For instance the shoe vending venue may be an existing store located at a given location. In such an embodiment a user may go to the store and place the order in the store. It will be appreciated that the foot data of the user may or may not have been acquired. In the case where the foot data have not been already acquired, such foot data can be acquired on site or the user may be directed to another location where the foot data acquisition may be performed.

In the case where the biometric foot data of the user have been acquired, the user may provide identification in order to be able to access and retrieve the foot data at a later time as explained further below.

In one embodiment, the foot data may be securely stored online and later retrieved on a website using an indication of the identity of the user. The skilled addressee will appreciate that the indication of the identity of the user may be provided according to various embodiments and may comprise a combination of login, password, biometric data, etc.

It will be further appreciated that the ordering of shoes may comprise paying upfront a fraction or a full amount associated with the transaction. The skilled addressee will appreciate that various embodiments may be used for paying the fraction or the full amount associated with the transaction. For instance anyone of Paypal™, debit card, credit card, check or cash may be used to do so.

In the case where the shoe vending venue is a virtual store, such as a merchant website, the website may provide a list of available shoe models. The list is accessible by the user, who may browse the merchant website until a desired shoe model is found. The user may then select the shoe model and provide an indication of a desire to complete the order for the selected shoe model. The skilled addressee will appreciate that various embodiments, departing from the scope of the present application, may be used in order to do so.

Prior to completing the order, the user may be required to provide the biometric foot data. It will be appreciated that the foot data may be provided according to various embodiments. For instance, the foot data may be provided directly to the merchant website by the user. Alternatively the foot data may be provided using another entity as explained further below. The skilled addressee will appreciate that the later embodiment will be of great advantage for various reasons. For instance, it will protect privacy, avoid disseminating foot data to merchant websites or make it cumbersome to the user. Moreover, such embodiment will enable a third party managing the system to control any transaction performed using the foot data and derive an advantage from them.

According to processing step 106, the foot data and the order are forwarded to the corresponding shoe manufacturer. It will be appreciated that the foot data may be provided to the shoe manufacturer using various embodiments. In a preferred embodiment, the foot data and the order are provided to the corresponding shoe manufacturer via a data network as explained further below.

The skilled addressee will appreciate that the shoe manufacturer will either manufacture the customized shoes or select the right and left shoes that best match the biometric dimensions from a stock of already manufactured shoes or choose any other means to customize the fit of each shoe.

In one embodiment, the customized shoes are manufactured by providing an existing shoe and inserting an appropriate insole in the existing shoe. The biometric foot data may correspond to a specific insole, which may be selected amongst a plurality of existing insoles. For instance, for each shoe size, the manufacturer may have access to a number of different insoles, each being adapted for a different width, arch type, and for proning or supining feet.

In an alternative embodiment, instead of being selected from a plurality of existing insoles, the appropriate insole may be manufactured according to the biometric foot data.

It will also be appreciated that the insole appropriate for the left customized shoe may be different from the insole appropriate for the right customized shoe. In a case in which, as explained above, the left and right feet of the user are different from each other, this would advantageously enable the customized shoes to be manufactured to be even more comfortable for the user.

In yet another embodiment, instead of providing an existing shoe with an appropriate insole, an entire customized shoe may be manufactured from scratch according to the biometric foot data.

Once the customized shoes are manufactured, the manufacturer may deliver the customized shoes to the user. It will be appreciated that the shoes may be delivered to the user according to various embodiments. In a preferred embodiment, the customized shoes may be delivered using postal service or a messenger service. Alternatively, the customized shoes may be delivered to the user at a retail shoe store.

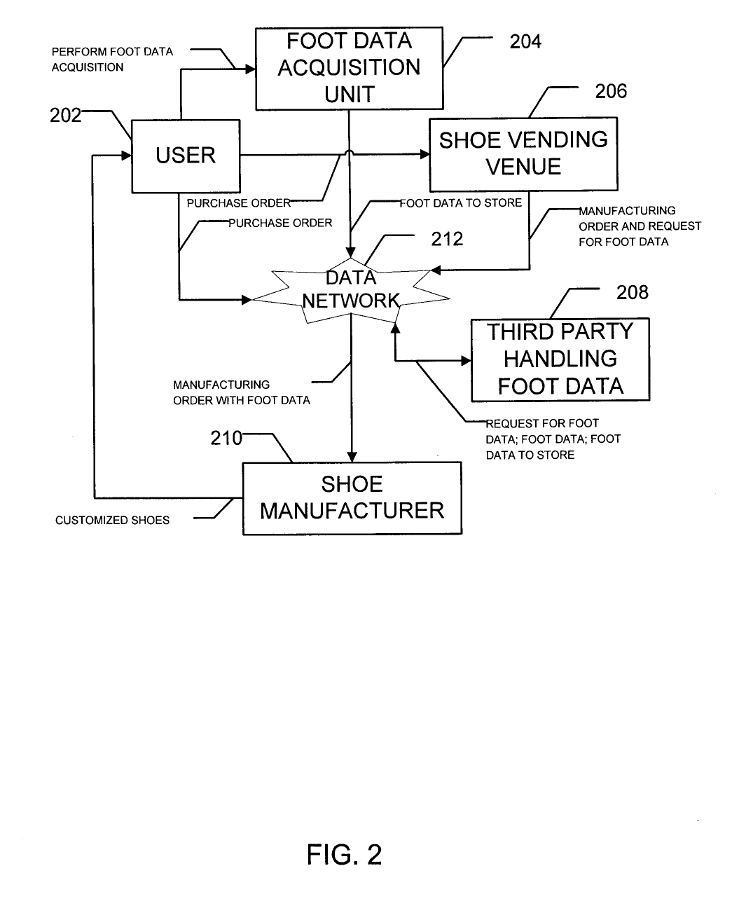

Now referring to FIG. 2, there is shown a block diagram of an embodiment of a system for providing customized shoes to a user.

This embodiment shows, a user 202, a foot data acquisition unit 204, a plurality of shoe vending venues an example of which is shoe vending venue 206, a third party handling foot data 208, a plurality of shoe manufacturers, an example of which is shoe manufacturer 210 and a data network 212.

The foot data acquisition unit 204, the shoe vending venue 206, the third party handling foot data 208 and the shoe manufacturer 210 are connected via the data network 212. It will be appreciated that the data network 212 may be of any type and may comprise at least one of a local area network (LAN), a metropolitan area network (MAN) and a wide area network (WAN). In a preferred embodiment, the data network 212 comprises the Internet.

The user 202 is looking to buy a pair of customized shoes manufactured by a given shoe manufacturer of the plurality of shoe manufacturers.

The foot data acquisition unit 204 is used for acquiring foot data of users and for providing the foot data to the third party handling foot data 208. It will be appreciated that the foot data acquisition unit 204 may be a shoe vending venue in one embodiment. In an alternative embodiment, the foot data acquisition unit 204 may be the third party handling foot data 208. It will be appreciated that an incentive may be provided by the third party handling foot data 208 to the foot data acquisition unit 204 for collecting the foot data. As mentioned above, the foot data acquisition unit 204 may be provided according to various embodiments. It will be appreciated by the skilled addressee that in one embodiment, the acquiring of foot data is only performed once.

Upon the performing of foot data acquisition, the acquired foot data is then associated with an indication of the identity of the user 202 to the third party handling foot data 208. The foot data acquisition unit 204 and the indication of the identity of the user 202 are provided to the third party handling foot data 208 via the data network 212.

The third party handling foot data 208 may comprise a database for storing foot data for a plurality of users and for ensuring it is provided to a given selected shoe manufacturer when appropriate, i.e. when a purchase order is performed. The skilled addressee will appreciate that the foot data corresponding to the user is stored together with an identification of the identity of the user 202. It will be appreciated that various embodiments may be provided for the third party handling foot data 208.

The user may then visit the shoe vending venue 206 with a desire to buy a given shoe model. It will be appreciated that the shoe vending venue 206 may be a “real” venue or a virtual venue.

In the case where the shoe vending venue 206 is a “real” venue, the purchase order is performed directly at the shoe vending venue 206.

In the case where the shoe vending venue 206 is a virtual venue, the purchase order is provided to the shoe vending venue 206 via the data network 212. The skilled addressee will appreciate that that the purchase order may be provided via the data network 212 according to various embodiments departing from the scope of the present application.

The shoe vending venue 206 may then provide a corresponding manufacturing order and a corresponding request for foot data. The manufacturing order is provided to the shoe manufacturer 210 via the data network 212. The corresponding request for foot data is provided by the shoe vending venue 206 to the third party handling foot data 208 via the data network 212. The corresponding request for foot data comprises the indication of the identity of the user 202 and an indication of the shoe manufacturer 210.

In turn, the third party handling foot data 208 provides corresponding foot data to the shoe manufacturer 210 via the data network 212. The corresponding foot data comprises an identification of the purchase order.

The shoe manufacturer 210 receives the corresponding manufacturing order together with the foot data. The shoe manufacturer 210 manufactures the customized shoes or provides customization by retrieving within existing stock a right and left shoe that best matches the biometric data and provides the user 202 with the customized shoes.

The skilled addressee will appreciate that the method disclosed herein is of great advantage for consumers and for manufacturers.

From a manufacturer's perspective, biometric foot data enables selling shoes directly to the consumer. Furthermore, given that biometric foot data is fairly stable over time, the manufacturer can continue to sell customized shoes over long time intervals to the same customers. The skilled addressee will appreciate that this returning customer base may advantageously be very valuable.

Given that direct sales from the manufacturer to the consumer reduce or eliminate the need for retail stores, using the collected biometric foot data can allow the manufacturer to increase profit margins while allowing consumers to pay less than would be the case in retail stores. The skilled addressee will appreciate that therefore, in some circumstances, these customized shoes, which are of greater quality than the ready-to-wear shoes purchased in stores, may be purchased at lower prices compared to those same ready-to-wear shoes.

Another advantage from the consumer's perspective is that a one-time measurement of biometric foot data enables the purchasing of customized shoes over long periods of time.

Furthermore, the method disclosed herein enables a user to have access to a wide range of manufacturers for obtaining customized shoes. The user is not limited to a single shoe manufacturer. The skilled addressee will further appreciate that this is of great advantage over the prior art.

Moreover, the skilled addressee will appreciate that using the embodiment disclosed herein, foot data may be collected using a given unique third party which will then provide the pertinent foot data to shoe manufacturers when required. The foot data of the user is therefore not stored by many entities or widely disseminated. It will be appreciated that since foot data may not change greatly after a certain age in a human, the step of collecting the foot data therefore does not need to be performed many times.

The skilled addressee will note that changes in foot biometric data may occur occasionally, for instance if the user has a foot injury or undergoes significant changes in weight. New biometric data for any user can always be collected to replace older data. However, old data is archived and can be reused, if for instance, the weight of the user and hence the foot reverts back to its original state.

It will be further appreciated that the third party handling foot data may advantageously receive an incentive from the shoe-vending venue.

The third party handling foot data may further receive an incentive from the shoe manufacturer. This incentive may be for maintaining the system, for managing the database, for collecting the biometric foot data or for any other service provided by the third party handling foot data.

The shoe manufacturer may be paid for manufacturing the customized shoes by the shoe vending venue upon receipt of the purchase order.

The shoe vending venue may be paid by the user to obtain the customized shoes.

It will be further appreciated that the collecting of foot data may be performed by an entity different than the third party handling foot data. Such party may then be entitled to receive an incentive from the third party handling the foot data.

Although the above description relates to a specific preferred embodiment as presently contemplated by the inventor, it will be understood that the invention in its broad aspect includes functional equivalents of the elements described herein.

1. A method for providing at least one customized shoe to a user, the method comprising:
receiving biometric foot data corresponding to the user;
receiving an order of a selected shoe model placed by the user;
forwarding the biometric foot data and the order to a manufacturer of the selected shoe model for enabling the manufacturer to manufacture at least one customized shoe based on the biometric foot data and on the order and to further deliver the at least one customized shoe to the user.

2. The method as claimed in claim 1, wherein the biometric foot data comprises at least one of length, width, arch type and pressure distribution along a foot's plantar surface.

3. The method as claimed in any one of claims 1 and 2, wherein the order is placed at a shoe vending venue.

4. The method as claimed in claim 3, wherein the shoe vending venue comprises a virtual shoe vending venue.

5. The method as claimed in claim 3, wherein the shoe vending venue comprises an existing shoe vending venue located at a given location.

6. The method as claimed in claim 5, wherein the acquisition of the biometric foot data is also performed at the shoe vending venue.

7. The method as claimed in any one of claims 1 to 6, wherein the acquisition of the biometric foot data is performed for a fee.

8. The method as claimed in any one of claims 1 to 7, wherein the forwarding of the biometric foot data and of the order is performed for a fee.

9. The method as claimed in any one of claims 1 to 8 further comprising, after receiving the biometric foot data:
storing the biometric foot data in a database;
before forwarding the biometric foot data and the order to a manufacturer, retrieving the biometric foot data from the database.

10. The method as claimed in claim 9, wherein the storage of the biometric foot data in the database is performed for a fee.

11. The method as claimed in any one of claims 9 and 10, wherein the retrieval of the biometric foot data from the database is performed for a fee.

12. The method as claimed in any one of claims 9 to 11 further comprising, before forwarding the biometric foot data and the order to the manufacturer:
acquiring an indication of the identity of the user;
associating the indication of the identity of the user with the biometric foot data of the user.

13. The method as claimed in claim 12, wherein the retrieval of the biometric foot data from the database comprises:
providing identification associated with the indication of the identity of the user in order to be able to access and retrieve the biometric foot data of the user.

14. The method as claimed in claim 13, wherein the database comprises an online database operatively connected to the Internet.

15. The method as claimed in claim 14, wherein the retrieval of the biometric foot data from the database comprises:
using the indication of the identity of the user on a website to retrieve the biometric foot data from the database.

16. The method as claimed in claim 15, wherein the biometric foot data is provided directly by the user on the website.

17. The method as claimed in claim 15, wherein the database is operated by a third party.

18. The method as claimed in claim 17, wherein the biometric foot data is provided by the third party.

19. The method as claimed in any one of claims 15 to 18, wherein the reception of the order of the selected shoe model comprises:
providing, on the website, a list of available shoe models accessible by the user to enable the user to select a desired shoe model;
receiving an indication of a desire to complete the order for the selected shoe model.

20. The method as claimed in any one of claims 1 to 19 further comprising:
receiving an upfront payment associated with the order from the user.

21. The method as claimed in claim 20, wherein the payment is performed using a mode of payment selected from a group consisting of PayPal™, debit card, credit card, check and cash.

22. The method as claimed in any one of claims 1 to 21, wherein the forwarding of the biometric foot data and of the order is performed via a data network.

23. The method as claimed in claim 22, wherein the data network comprises at least one of a local area network (LAN), a metropolitan area network (MAN) and a wide area network (WAN).

24. The method as claimed in claim 23, wherein the data network comprises the Internet.

25. The method as claimed in any one of claims 1 to 24 further comprising, before receiving the biometric foot data:
acquiring the biometric foot data from the user.

26. The method as claimed in claim 25, wherein the acquisition of the biometric foot data is performed using an Aetrex™ iStep SP5000 foot analysis device.

27. The method as claimed in any one of claims 1 to 26 further comprising, after forwarding the biometric foot data and the order:
manufacturing the at least one customized shoe.

28. The method as claimed in claim 27, wherein the manufacturing of the at least one customized shoe comprises:
providing an existing shoe selected according to the order;
inserting an appropriate insole in the existing shoe.

29. The method as claimed in claim 28 further comprising, before inserting the appropriate insole in the existing shoe:
selecting the appropriate insole from a plurality of existing insoles according to the biometric foot data.

30. The method as claimed in claim 28 further comprising, before inserting the appropriate insole in the existing shoe:
manufacturing the appropriate insole according to the biometric foot data.

31. The method as claimed in any one of claims 1 to 30, wherein the at least one customized shoe is delivered to the user using one of postal service and a messenger service.

32. A system for providing at least one customized shoe to a user, the system comprising:
a data network;
a foot data acquisition unit operatively connected to the data network for acquiring biometric foot data of the user;
a shoe vending venue operatively connected to the data network for enabling the user to select a given shoe model and to place an order of the selected shoe model;
a shoe manufacturer operatively connected to the data network for receiving the biometric foot data and the order, and further for manufacturing customized shoes according to the biometric foot data and to the order, and further for delivering the at least one customized shoe to the user.

33. The system as claimed in claim 32 further comprising a third party handling foot data operatively connected to the data network for receiving the biometric foot data and for forwarding the biometric foot data to the shoe manufacturer.

34. The system as claimed in claim 33, wherein the third party handling foot data further comprises a database for storing the biometric foot data.

35. The system as claimed in claim 34, wherein the foot data acquisition unit is further adapted to provide an indication of the identity of the user to the third party handling foot data.

36. The system as claimed in claim 35, wherein the third party handling foot data is further adapted for associating the biometric foot data of the user to the indication of the identity of the user.
